(19) United States
(12) Patent Application Publication
(10) Pub. No.: US 2015/0278811 A1
(43) Pub. Date: Oct. 1, 2015

(54) Systems and Methods for Facilitating Authorisation of Payment

(71) Applicant: COMMONWEALTH BANK OF AUSTRALIA, Sydney, NSW (AU)

(72) Inventors: Nikesh Anand Lalchandani, Sydney (AU); Michael Baumann, Sydney (AU); Timothy Robert Hogarth, Toronto (CA)

(73) Assignee: COMMONWEALTH BANK OF AUSTRALIA, Sydney, NSW (AU)

(21) Appl. No.: 14/431,432

(22) PCT Filed: Nov. 21, 2013
(86) PCT No.: PCT/AU13/01339

§ 371 Date: Mar. 26, 2015

(30) Foreign Application Priority Data
Mar. 8, 2013 (AU) 2013900807

(51) Int. Cl. G06Q 20/40; G06Q 20/32; G06Q 20/20; G06Q 20/10

(52) U.S. Cl. CPC G06Q 20/40; G06Q 20/108; G06Q 20/3278; G06Q 20/202; G06Q 20/3223

(57) ABSTRACT

A method of operating a matching server for facilitating authorization of payment for a transaction between a customer and a merchant at a point of sale is described. The method includes receiving a merchant match request from a merchant bank server, receiving a customer match request from a customer bank server, and performing a matching operation to determine whether the transaction information included in the merchant match request and the transaction information included in the customer match request satisfy a transaction authorization criteria. If the transaction authorization criteria is satisfied payment for the transaction is deemed to be authorized, and a merchant bank confirmation confirming authorization of the payment for the transaction is communicated to one or both of the merchant bank server and the merchant apparatus.

### FIELD OF THE INVENTION

The present invention relates to systems and methods for facilitating the authorization of payment.

### BACKGROUND OF THE INVENTION

Customer are increasingly paying for goods or services purchased from a merchant at a point of sale using electronic means, such as a credit card or a debit card.

From a merchant perspective, unlike cash purchases (where a merchant gains possession of currency as soon as it is handed over), an electronic transaction can take time to be finalised—i.e. for money to actually be transferred from the customer's account to the merchant's account. This being the case, the merchant cannot necessarily look at its bank account and immediately confirm that payment has actually been received. Accordingly, some form of transaction confirmation is typically required which gives the merchant confidence that they will be paid, despite the payment no having yet occurred.

From the perspective of the customer, and financial services provider, there are competing goals of making it simple to complete an electronic transaction, and making an electronic transaction secure—e.g. ensuring that when an electronic transaction is made it has been authorized by the customer in question.

Authorization may be provided electronically by, for example, swiping the customer's debit card and providing a personal identification number (PIN) at a merchant terminal. The merchant terminal upon receiving the customer's authorization, along with the customer's banking details from the card, may communicate the authorization and the customer's banking details to the merchant bank, which may in turn request the customer bank for payment from the customer's account. The customer bank may perform checks on the customer's account, for example, determining whether the customer's account has sufficient funds for the transaction. If the checks are successfully passed, a transaction is approved. A notification of the transaction approval is then sent to the merchant terminal.

One potential drawback of authorizing payments in this way is that confidential or sensitive information, such as the customer's banking details, is passed on to the merchant or the merchant's employee, leading to a possibility of unauthorized or fraudulent use of such information.

Reference to any prior art in the specification is not, and should not be taken as, an acknowledgment or any form of suggestion that this prior art forms part of the common general knowledge in any jurisdiction or that this prior art could reasonably be expected to be understood, regarded as relevant and/or combined with other pieces of prior art by a person skilled in the art.

### SUMMARY OF THE INVENTION

### Matching Server

According to a first aspect of the invention there is provided a method of operating a matching server for facilitating authorization of payment for a transaction between a customer and a merchant at a point of sale, the method including the steps of:

receiving a merchant match request from a merchant bank server, the merchant match request originating from a merchant apparatus and including transaction information in respect of the transaction;

receiving a customer match request from a customer bank server, the customer match request originating from a customer device and including transaction information in respect of the transaction;

performing a matching operation to determine whether the transaction information included in the merchant match request and the transaction information included in the customer match request satisfy a transaction authorization criteria;

if the transaction authorization criteria is satisfied, determining the payment for the transaction to be authorized and generating a merchant bank confirmation confirming authorization of the payment for the transaction and communicating the merchant bank confirmation to one or both of the merchant bank server and the merchant apparatus.

In response to the transaction authorization criteria being satisfied, the method may further include generating a customer bank confirmation confirming authorization of the transaction and communicating the customer bank confirmation to one or both of the customer bank server and the customer device.

The merchant match request and the customer match request may each further include merchant identification information and/or transaction amount information.

The customer match request may further include a customer bank identifier for identifying the customer bank.

The transaction information in the merchant match request and the transaction information in the customer match request may include a transaction identifier.

The transaction information may be generated by the merchant apparatus and communicated to the customer device.

The transaction information may be communicated to the customer device using NFC data exchange format (NDEF). The transaction information may be encoded in an image displayed at the merchant apparatus and captured by an image capture device of the customer device.

The transaction authorization criteria may require a complete matching, a partial matching, or a relationship between the transaction information included in the customer match request and the transaction information included in merchant match request.

If, in performing the matching operation, the transaction information included in the merchant match request and the transaction information included in the customer match request do not satisfy the transaction authorization criteria but meet a minimum matching criteria, the matching server may be configured to determine that the merchant match request corresponds to the customer match request but that a transaction discrepancy exists.

If a transaction discrepancy exists, the matching server may generate and communicate a discrepancy message to the merchant bank server and/or the customer bank server.

Merchant Apparatus

According to a second aspect of the invention there is provided a method of operating a merchant apparatus at a point of sale to facilitate authorization of a payment for a transaction between a customer and a merchant, the method including;

generating transaction information including at least a transaction identifier;

communicating the transaction information to a customer device, the customer device being configured to communicate the transaction information to a customer bank server, the customer bank server being configured to communicate the transaction information to a merchant server in a customer match request;

generating a merchant transaction request including at least the transaction information;

communicating the merchant transaction request to a merchant bank server, the merchant bank server being configured to communicate the transaction information to the matching server in a merchant match request; and

receiving a merchant confirmation confirming authorization of the payment for the transaction,

wherein the merchant confirmation is received only if the matching server receives a customer match request which, when compared with the merchant match request, satisfies a transaction authorization criteria.

The merchant confirmation may be received from the matching server or from the merchant bank server.

The transaction information may be communicated to the customer device using NFC data exchange format (NDEF). The transaction information may be encoded in an image displayed by the merchant apparatus and captured by an image capture device of the customer device. The image may be a QR code.

Customer Device

According to a third aspect of the invention there is provided a method of operating a customer device at a point of sale to facilitate authorization of a payment for a transaction between a customer and a merchant, the method including:

receiving transaction information from a merchant apparatus, the transaction information including at least a transaction identifier;

generating a customer transaction request including at least the transaction information;

communicating the customer transaction request to a customer bank server, the customer bank server being configured to communicate the transaction information to a matching server in a customer match request.

The transaction information may be received using NFC data exchange format (NDEF). The transaction information may be received by operating the customer device to capture an image displayed by the merchant apparatus. The image may be a QR code.

Merchant Bank Server

According to a fourth aspect of the invention there is provided a method of operating a merchant bank server for facilitating authorization of a payment for a transaction between a customer and a merchant at a point of sale, the method including the steps of:

receiving a merchant transaction request from a merchant apparatus, the merchant transaction request including transaction information;

generating a merchant match request including at least the transaction information;

communicating the merchant match request to a matching server, the matching server being configured to receive a customer match request from a customer bank server, the customer match request including customer match request transaction information received at the customer bank server from a customer device; and

receiving from the matching server a merchant bank confirmation confirming authorization of the transaction,

wherein the merchant bank confirmation is received only if the matching server determines the merchant match request and the customer match request satisfy a transaction authorization criteria.

The method of operating the merchant bank server may further include:

generating a merchant confirmation confirming authorization of the payment for the transaction; and

communicating the merchant confirmation to the merchant apparatus.

Customer Bank Server

According to a fifth aspect of the invention there is provided a method of operating a customer bank server for facilitating authorization of a payment for a transaction between a customer and a merchant at a point of sale, the method including the steps of:

receiving a customer transaction request from a customer device, the transaction request including transaction generated by a merchant apparatus and communicated to the customer device;

generating a customer match request including at least the transaction information;

communicating the customer match request to a matching server, the matching server being configured to receive a merchant match request from a merchant bank server, the merchant match request including merchant match request transaction information received at the merchant bank server from the merchant apparatus; and

receiving from the matching server a customer bank confirmation confirming authorization of the transaction,

wherein the customer bank confirmation is received only if the matching server determines the merchant match request and the customer match request satisfy a transaction authorization criteria.

The method of operating the customer bank server may further include:

generating a customer confirmation confirming authorization of the payment for the transaction; and

communicating the customer confirmation to the customer device.

According to a further aspect of the invention there is provided a computer processing system configured to implement a method as described above.

According to a further aspect of the invention there is provided a computer readable storage medium including instructions executable by a computer processing device to cause the device to perform a method as described above.

### BRIEF DESCRIPTION OF THE DRAWINGS

FIG. 1A is a diagram of a system in which embodiments of the present invention can be implemented.

FIG. 1B is a functional block diagram of one example of a computer processing system.

FIG. 2 is a diagram illustrating communications between entities shown in the system of FIG. 1A in order to authorize a transaction in accordance with an embodiment of the present invention.

FIG. 3 is a flow diagram illustrating a method of operating a matching server in accordance with an embodiment of the invention.

FIG. 4 is a flow diagram illustrating a method of operating a merchant apparatus in accordance with an embodiment of the invention.

FIG. 5 is a flow diagram illustrating a method of operating a customer device in accordance with an embodiment of the invention.

FIG. 6 is a flow diagram illustrating a method of operating a merchant bank server in accordance with an embodiment of the invention.

FIG. 7 is a flow diagram illustrating a method of operating a customer bank server in accordance with an embodiment of the invention.

FIG. 8 is a diagram illustrating communications between entities shown in the system of FIG. 1A in order to authorize a transaction in accordance with an alternative embodiment of the invention.

### DETAILED DESCRIPTION OF THE EMBODIMENTS

Described herein are systems and methods for facilitating authorization of payment from a customer to a merchant at a point of sale.

The term “bank” as used in this specification refers generally to a financial institution providing financial services.

System Overview

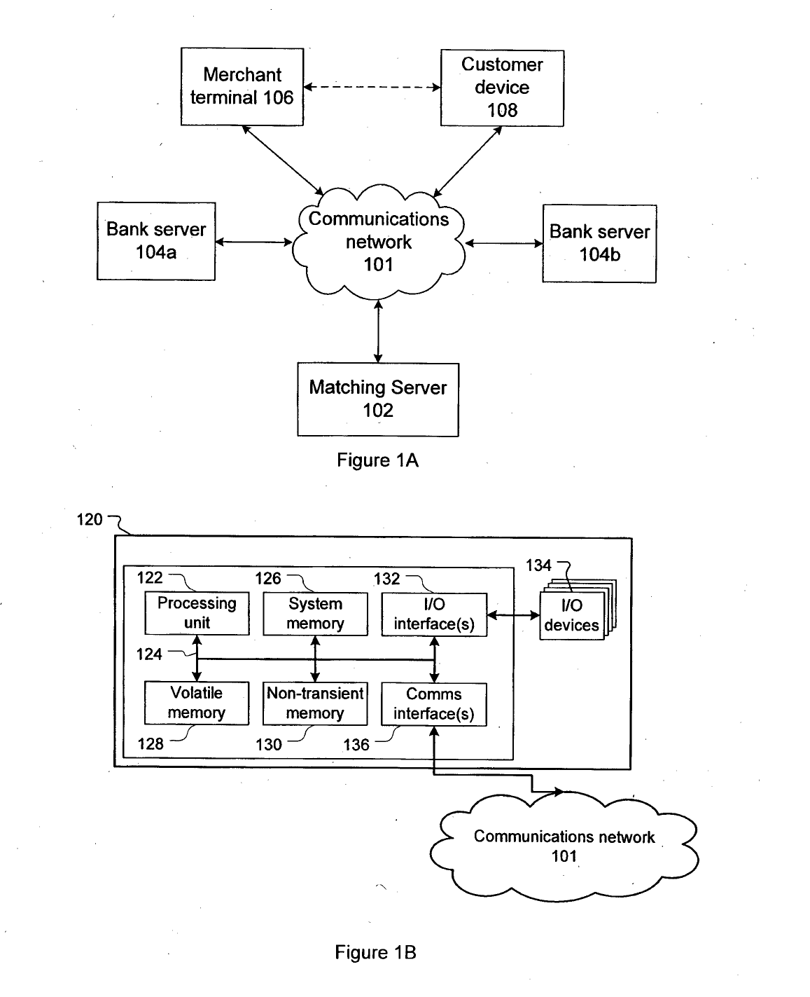

FIG. 1A illustrates a system 100 in which embodiments of the present invention are performed. System 100 includes a communications network 101 enabling communication between a plurality of computer processing systems, which include a matching server 102, bank servers 104, a merchant apparatus 106, and a customer device 108.

Network 101 is a communications network such as the Internet, and may allow for wired or wireless communication by any appropriate physical apparatus and network protocols. For example, network 101 may include physical-layer networks, such as wired networks (e.g. fibre optic networks) and wireless networks (e.g. satellite, Wi-Fi and/or or mobile networks).

Customer device 108 is a portable electronic device, such as a mobile phone, laptop or tablet device, carried by a customer shopping at a merchant shop. As described below, customer device 108 is configured to allow a customer to authorize a transaction with a merchant.

Merchant apparatus 106 is operated by a merchant at a physical point of business. This may, for example, be a shop where goods/services are sold, or a vehicle (such as a taxi or other mobile sales vehicle). Merchant apparatus 106 is configured to allow the merchant to transact with customers to make a sale. Merchant apparatuses 106 may include point of sale terminals (e.g. EFTPOS—electronic funds transfer at point of sale—terminals), smart card readers, cash registers, near-field communication devices, and the like, or a combination of such devices.

Each bank server 104 is maintained by a bank (or other financial institution) and configured to provide financial services to customers (via customer devices 108) and/or merchants (via merchant apparatuses 106). For the purposes of illustration, two bank servers are shown—a customer bank server 104a (being the bank server operated by the customer's bank or financial institution), and bank server 104b (being the bank server operated by the merchant's bank or financial institution).

Matching server 102 is a computer server configured to receive communications from and transmit communications to at least the bank servers 104 in order to facilitate the authorization of transactions between merchants and customers.

Although FIG. 1A depicts a single matching server 102, two bank servers 104, one merchant apparatus 106, and one customer device 108, it will be appreciated that additional matching servers 102, bank servers 104, merchant apparatuses 106, and/or customer devices 108 will typically be involved in system 100. For example, at any given time multiple merchants (using multiple merchant apparatuses) may be transacting with multiple customers (using multiple customer devices). Further, different merchants and customers may, of course, communicate with different bank servers 104—or, indeed, the same bank servers 104. For example, while FIG. 1A shows the customer bank server 104a as being different to the merchant bank sever 104b if the merchant and customer use the services of the same bank/financial institution, the bank server 104 of the merchant will be the same as (or operated by the same entity as) the bank server 104 of the customer.

Merchant apparatus 106 may be (or include) an existing card-based merchant terminal configured to perform electronic transactions at a point of sale. Such terminals include, for example, Ingenico iWL255, iPP350, iCT250, iUN, and similar terminals supplied by Ingenico or other suppliers (e.g. Verifone). Embodiments of the invention, as discussed below, can be performed using such existing merchant terminals without requiring any hardware upgrade/modification. Embodiments of the present invention make use of message protocols between the merchant terminal and bank server 104, with various aspects of the invention making use of messages which send slightly altered data—e.g. not including a customer card number. A merchant terminal used to implement embodiments of the present invention can also be used to support existing card payment methods and systems.

As noted, each of the matching server 102, the bank servers 104, the merchant apparatus 106, and customer device 108 is a computer processing system. FIG. 1B illustrates one example of a general computer processing system 120, the basic architecture of which may be used for the matching server 102, bank servers 104, merchant apparatuses 106, and customer devices 108.

Computer processing system 120 includes at least one processing unit 122 which may be a single computational processing device (e.g. a microprocessor or other computational device) or a plurality of computational processing devices. Through a communications bus 124, processing unit 122 is in data communication with a system memory 126 (e.g. a read only memory storing a BIOS for basic system operations), a volatile memory 128 (e.g. random access memory such as one or more DRAM modules), and a non-transient memory 130 (e.g. one or more hard disk drives, solid state drives, flash memory devices and suchlike). Instructions and data to control operation of processing unit 122 are stored on system, volatile, and/or non-transitory memory 126, 128, and 130.

Computer processing system 120 also includes one or more input/output interfaces 132 which allow system 120 to interface with a plurality of input/output devices 134. As will be appreciated, a wide variety of input/output devices may be used depending on the device/system/apparatus in question, for example keyboards, pointing devices, touch-screens, touch-screen displays, displays, microphones, speakers, hard drives, solid state drives, flash memory devices and the like. Computer processing system 120 also includes one or more network communications interfaces 136, such as Network Interface Cards, modems and the like, allowing for wired or wireless connection to communications network 101.

Computer processing system 120 stores in memory and runs one or more applications allowing operators to operate the system 120. Such applications will typically include at least an operating system such as Microsoft Windows, Apple OSX, Unix, Linux, Apple iOS, Google Android, or other operating system. System 120 will also typically have additional applications installed, the nature of which will depend on the device in question. For example, and as discussed further below, the customer device 108 and merchant apparatus 106 in the preferred embodiment each have at least a banking application installed, facilitating secure and trusted communications between the customer device 108 and its bank server 104a, and between the merchant apparatus 106 and its bank server 104b.

Communication with communications network 101 (and other devices, apparatuses, servers, apparatuses connected thereto) will typically be by the protocols set out in the layers of the Open Systems Interconnection (OSI) model of computer networking. For example, applications/software programs being executed by computer processing system 120 may communicate using one or more transport protocols, e.g. the Transmission Control Protocol (TCP) or the User Datagram Protocol (UDP). Alternative communications protocols may, of course, be used.

While FIG. 1B provides a general overview of a suitable computer processing system, it will, of course, be appreciated that the matching server 102, bank servers 104, merchant apparatus 106 and customer devices 108 may be of alternative system types. Further, and as noted, each different system may have different I/O interfaces and I/O devices, different communications interfaces, and/or different software applications installed.

Communications Overview

In the present invention, a customer device 108 and a merchant apparatus 106 are configured to communicate transaction information between each other. Typically this will occur at a point of sale while the customer device 108 and merchant apparatus 106 are in physical proximity with each other.

A variety of devices and protocols may be used to enable communication between the customer device 108 and merchant apparatus 106. For example, a merchant apparatus 106 and customer device 108 may be provided with one or more input/output devices 134 (and corresponding interfaces 132) to allow for direct communication between them. Any appropriate devices (and communication protocols) may be used, such as near-field communication (NFC) devices and protocols (e.g. the NDEF protocol), Bluetooth devices and protocols, and infrared communication devices and protocols.

Alternatively, the merchant apparatus 106 and customer device 108 may communicate between each other using visual techniques. For example, the merchant apparatus 106 may include a barcode or QR code generator and a display for displaying a generated bar or QR code. In this case the merchant apparatus 106 can be operated to generate and display a bar or QR code and the customer can operate the customer device 108 to capture the bar or QR code using an image capture device such as a camera (and decode the information encoded therein using appropriate software). Conversely, the customer device 108 can generate and display a bar or QR code and the merchant apparatus 106 can include an image capture device for capturing a code (or other visual image) displayed by the customer device 108.

Further alternatively, the merchant and apparatus 106 and customer device 108 may communicate information using audio techniques. For example, the merchant apparatus 106 may include an audio signal generator and/or speaker for generating and playing an audio signal/sound waves. This can be played, and the customer can operate the customer device 108 to capture the audio signal using an microphone (and decode the relevant information from the audio signal using appropriate software).

The merchant apparatus 106 and customer device 108 may also/alternatively communicate biometric information for the purposes of identification/matching transactions. For example, the merchant apparatus 106 may include a biometric capture device (e.g. a camera for capturing a facial or eye image, a camera/scanner for capturing fingerprint data) for capturing biometric data which is digitised and communicated through to the matching server 102 for matching.

Still further alternatively, the merchant apparatus 106 and customer device 108 may communicate with each other via networked communication means, such as SMS, instant messaging, email or the like.

Still further alternatively, the customer may manually enter transaction information provided by the merchant into their device 108 using, for example, a keyboard, touch screen inputs, or keypad.

In addition to being configured to communicate with each other (either directly or over a communications network 101), the merchant apparatus 106 and customer device 108 are configured to communicate with their respective bank servers 104.

Communications between the customer device 108 and its respective bank server 104 are via communications network 101. In many cases a customer device 108 will communicate with the relevant bank server 104 by wireless means, e.g. over a mobile network (e.g. 3G or 4G network) or by WiFi or similar.

Communications between the merchant apparatus 106 and its corresponding bank server 104 are also over communications network 101, and by either a wired or wireless means. In one arrangement, the merchant apparatus includes a merchant terminal, such as an EFTPOS (electronic funds transfer at point of sales) machine, which communicates messages using the ISO8583 or AS2805 standard.

The bank servers 104 are also configured to communicate with each other and with the matching server 102 over communications network 101. These communications will typically be by a dedicated wired connection, however may make use of any appropriate hardware and any appropriate communications protocols.

Transaction Authorization

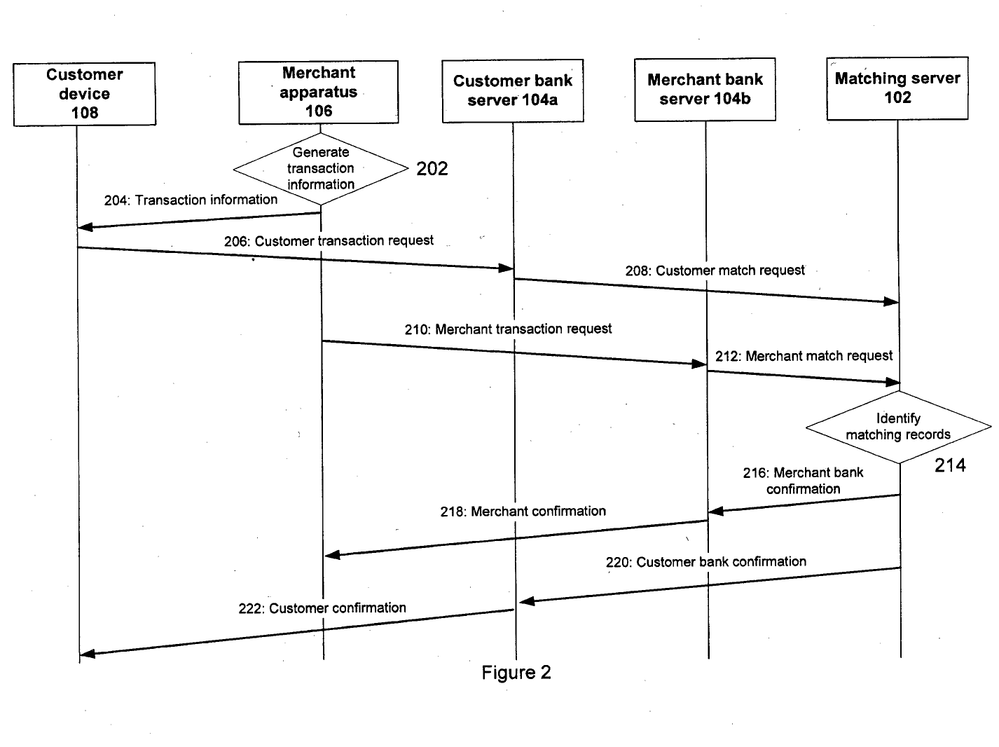

FIG. 2 illustrates information communicated between the various components of system 100 in order to authorize a transaction in accordance with an embodiment of the invention.

A transaction, at a point of sale takes place when a customer purchases goods or services from a merchant. When paying for the goods or services via electronic means, the customer provides payment authorization so that a bank associated with the customer (the customer bank) can transfer funds to a bank associated with the merchant (the merchant bank). Once a sale has been authorized by the customer, the customer bank server 104a (i.e. a bank server operated by the customer's bank) notifies the matching server 102 that the customer has authorized the transaction. The matching server 102 also receives a corresponding notification from the merchant bank server 104b and, once matching notifications have been received, advises the merchant bank 104b of this—i.e. that the transaction has been authorized by the customer.

As noted above, a customer and a merchant may use the same or a different bank/financial services provider, and as such a given bank server 104 may take different roles in the authorization and completion of a transaction (e.g. be a merchant bank server in one transaction, a customer bank server in another transaction and/or both a merchant bank server and a customer bank server in yet another transaction).

Although the customer may authorize a transaction at a certain time (e.g. whilst at the point of sale) the actual transfer of funds from the customer's bank account to the merchant's bank account may not occur until sometime later. In this case confidence needs to be provided to the merchant that the transaction will actually proceed despite money not having actually been transferred.

In the embodiment depicted in FIG. 2, once a customer has indicated an intention to make a purchase, the merchant (using the merchant apparatus 106) generates transaction information for communication to the customer device 108. The transaction information allows identification of the particular transaction and in this particular embodiment includes a unique transaction identifier, merchant identification information (allowing the merchant making the sale to be identified and which may include, for example, merchant location information and, if the merchant has multiple stores/terminals, merchant terminal identification information), and transaction amount information (allowing the amount of the transaction to be determined). The transaction identifier is generated to allow the specific transaction to be uniquely identified. In some cases the transaction identifier may be universally unique. In other embodiments the transaction identifier may be unique only to the merchant (or even merchant terminal)—in which case both the transaction identifier and the merchant information/merchant terminal information are both required to uniquely identify a specific transaction.

The transaction identifier may include letters or numbers, and may be serially or randomly generated. The transaction identifier may include different portions, for example a set number of digits/characters enabling identification of the merchant and/or a set number of digits/characters enabling identification of the customer (e.g. part or all of a number from a customer's transaction card), together with a set number of digits/characters uniquely identifying the particular transaction for that merchant. In this case, prior to generating the transaction information the merchant may use their merchant apparatus 106 to obtain details from a transaction card of the customer (using, for example, a card or chip reader).

Additional transaction information may also be generated′ and provided to the customer. For example transaction currency information, transaction time information, transaction location information, merchant bank information (enabling the identification of the merchant's bank and/or bank account). Similarly, and as discussed in relation to an alternative embodiment below, less information (e.g. a transaction identifier only) may be provided to the customer.

Where relevant, the merchant apparatus 106 may also generate related information and communicate this to the customer device 108—for example using NDEF. Such related information can include information such as loyalty program information, merchant-funded offers etc.

Once generated, the transaction information (in this embodiment including a transaction identifier, merchant identifier, and amount information) is communicated from the merchant apparatus 106 to the customer device 108 in communication 204. As discussed above, this communication may be achieved in a variety of different ways. In a preferred embodiment, the merchant apparatus 106 is operated to push the transaction information from the merchant apparatus 106 to the customer device 108 using NFC and the NDEF protocol. In alternative embodiments, the merchant apparatus 106 may communicate the transaction information to the customer device 108 by operating the merchant apparatus 106 to display a bar code, QR code, or other visual information in a display which includes the transaction information (in encoded form or otherwise), which the customer can then capture using their device 108. Further alternatively, the merchant apparatus 106 may be operated/configured to communicate the transaction information to the customer device 108 by Bluetooth, infrared, sound waves, WiFi or other direct or networked communication means.

Once the customer device 108 receives the transaction information, the customer device 108 prepares a customer transaction request for transmission to the customer bank server 104a. In the preferred embodiment, the customer device 108 has installed on it (and is running) a banking application which facilitates secure and trusted communications between the customer device 108 and the customer bank server 104a. Such banking applications are known and typically implement various security measures and protocols to authenticate a customer (and device 108) so that the customer has confidence that they and only they can authorize operations on their bank accounts, and so that the banking server 104a has confidence that messages alleged to be from a particular customer are indeed being sent from that customer.

In the present embodiment, the banking application is configured/programmed to provide the additional functionality of receiving the transaction information from the merchant apparatus 106, decoding it (if required, for example where the information is communicated as a QR or other code), generating a customer transaction request, and transmitting the customer transaction request to the customer bank server 104a (in communication 206).

The customer transaction request includes at least the transaction information (communicated at 204a). The customer transaction request may also include a customer account identifier identifying a particular account of the customer that the customer wishes the transaction amount to be paid/taken from. Alternatively, the banking application may run on a default account so that the customer does not need to specify an accounticommunicate this to the bank server 104a.

The customer transaction request may also include additional information, for example a GPS location of the customer device 108 (which can then be compared against the merchant location), a level of authorization provided by the customer (e.g. a Swipe acknowledgement, entry of a PIN on the customer device, capture of a fingerprint/voice signature on the customer device or other authorization), discount coupon information to be applied to the transaction, loyalty program information.

Communication of the customer transaction request from the customer device 108 to the customer bank server 104a at 206 serves to provide relevant transaction details to the bank server 104a and to indicate to the bank server 104a that the customer has approved the transaction as per the transaction details. Accordingly, before communicating the customer transaction request to the bank server 104a the banking application will typically require an explicit confirmation to be made by the customer that the customer authorizes the transaction to be made from the selected (or default) account. This will typically be by requiring the customer to activate a “confirm transaction” control or similar provided on the customer device 108. The banking application may also require additional authentication/verification steps to be taken by the customer in order to reduce the likelihood of a non-authorized person making the transaction using the customer's device/banking application.

Alternatively, in embodiments where the customer has to actively acquire the transaction information from the merchant apparatus 106 (e.g. by capturing a QR code or other visual image, or accepting a NFC communication from the merchant apparatus 106), the active acquisition of the transaction information while the customer's baking application is running and “live” (i.e. any authentication/security steps have been completed) may be taken as the customer's confirmation that the transaction is valid. In this case the banking application may be programmed/configured to automatically generate and communicate the customer transaction request on receipt of the transaction information.

On receipt of the customer transaction request, the customer bank server 104a generates a customer match request and communicates this to the matching server 102 (communication 208). As discussed further below, the purpose of the customer match request is to provide the matching server 102 with information that the matching server 102 uses to identify a corresponding (and in some way matching) match request received from a merchant. To this end, the minimum information sent in the customer match request (and the merchant match request as discussed below) will be dictated by the information the matching server 102 requires to properly match a received customer match request with a received merchant match request. Match requests are discussed further below.

In addition to the minimum match information required by the matching server 102, the customer match request may include additional information to facilitate operation of the system and/or actual payment in respect of the transaction. For example, in one embodiment of the invention once a transaction is authorized payment is eventually made by the merchant bank requesting funds from the customer bank. To facilitate this the customer match request may include customer account information (for example an EFTPOS number, a card expiry date, and/or other identifying information) which the matching server 102 can pass back to the merchant bank server 104b to allow it to effect payment. Even in this case, however, the customer account information is not provided to the merchant apparatus 106 (or merchant).

In some embodiments the customer bank server 104a may perform security and/or account checks based on the information in the customer transaction message and/or details associated with the customer account. For example, the customer bank server 104a may check the transaction amount against the balance of the customer account from which the payment is to be made. If the balance is insufficient the customer bank server 104a will not generate and communicate a customer match request. Instead, the customer bank server 104a may send a message back to the customer advising them of the insufficient funds.

The customer bank server 104a also stores at least the transaction information in an appropriate data structure (on a physical memory such as non-transient memory 130) for later use.

Matching server 102 receives the customer match request from the customer bank server 104a. The operation of the matching server 102 is described in further detail below.

Returning to the merchant apparatus 106, in addition to communicating the transaction information to the customer device 108, the merchant apparatus 106 also generates a merchant transaction request and communicates this to the merchant bank server 104b (communication 210).

As with the customer device 108, the merchant apparatus 106 also has a banking application installed, allowing for secure and trusted communications between the merchant terminal 106 and the merchant bank server 104b. The banking application running on the merchant apparatus 106 is configured/programmed to enable the generation of the merchant transaction request based on the transaction information, and the communication of the message to the merchant bank server 104b. This communication may be automatically performed on the generation and communication of the transaction information to the customer device 108, or may require further input from a merchant user to confirm the transaction (e.g. by activation of a “transmit transaction information” control or similar).

The merchant transaction request includes at least the transaction information. Communication 210 of the merchant transaction request to the merchant bank server 104b can be performed as soon as the transaction information has been generated—e.g. before, after, or at the same time as communicating the transaction information to the customer at 204.

On receipt of the merchant transaction request, the merchant bank server 104b generates a merchant match request and communicates this to the matching server 102 (communication 212). As with the customer match request, the minimum information included in the merchant match request will be dictated by the information required by the matching server 102 to properly identify and match a corresponding customer match request. Additional information may also be included in the merchant match request to facilitate operation of the system and/or actual payment in respect of the transaction.

In one embodiment, the matching server 102 may be configured to match customer and merchant match requests on the strength of a transaction identification identifier only—though this requires the system to make use of universally unique transaction identifiers that can be used to identify a specific transaction without reference to any other information. In this case, the customer and merchant match requests may include only the transaction identifier.

In alternative embodiments the matching server 102 may be configured to only match customer and merchant requests if additional matching information is provided. In this case the matching server 102 compares merchant and customer match requests to determine wither one or more transaction authorization criteria are satisfied. Herein “transaction authorization criteria” is used to refer to a single criterion or multiple criteria which must be matched in order for the matching server to consider a transaction authorized.

For example, the matching server 102 may implement transaction authorization criteria that require match requests to include matching transaction amounts. This prevents a transaction being matched where the transaction identifiers match (indicating a corresponding merchant and customer match request) but the transaction amounts differ—indicating a customer has authorized a transaction for one amount, but a merchant has requested match of a transaction for a different amount. The matching server 102 may also (or alternatively) require matching requests to include merchant identification information.

While the customer and merchant match requests will necessarily include the minimum information required by the matching server 102 to be able to satisfy the transaction authorization criteria, they may also include additional information to facilitate operation of the system. For example, the customer and merchant match requests may include “reply destination” information enabling the merchant sever 102 to identify where information should be sent in the event a transaction is successfully matched (or in the event that a match request is not successfully matched).

The merchant bank server 104b also stores at least the transaction information in an appropriate data structure (on a physical memory such as non-transient memory 130) for later use.

As described, matching server 102 is programmed/configured to receive match requests from both customer and merchant bank servers 104a/104b. The matching server 102 is configured to only accept match requests from authorized bank servers 104, and communications between bank servers 104 and the matching sever 102 are secure and authenticated. As will be appreciated, matching server 102 will receive multiple match requests from multiple bank servers at different times. When the matching sever 102 receives a match request it generates a match request record (using the information from the match request) and stores the match request record in a defined data structure (e.g. a table, spreadsheet, database or other appropriate structure), which is physically stored in a memory such as non-transient memory 130.

By way of example, the matching server 102 may store match request records in a simple table structure as depicted in Table 1 below:

TABLE 1
example matching server data structure

| Record | Time | | | | |
|---|---|---|---|---|---|
| ID | received | Received from | Tx ID | Merchant | Amount |
| 00008 | 2013-10-20 | Merchant A | 12345 | Merchant A | $100 |
| | 10:00:00.00 | | | | |
| 00009 | 2013-10-20 | Customer B | ABCDE | Merchant B | $50 |
| | 10:00:00.11 | | | | |
| 00010 | 2013-10-20 | Merchant B | ABCDE | Merchant B | $500 |
| | 10:00:05.00 | | | | |
| 00011 | 2013-10-20 | Customer C | 12345 | Merchant A | $100 |
| | 10:00:05.22 | | | | |
| 00012 | 2013-10-20 | Merchant D | !@#$% | Merchant C | $200 |
| | 10:05:22.01 | | | | |

In this example, the matching server 102 assigns each match request record with a local identifier for use by the matching server 102 to identify each particular request received. For each match request the matching server also stores the time the match request was received at the server 102 and where the matching request was received from (this may be extracted from information in the match request itself or based on communications protocol information identifying the source of the match request).

In this example, the transaction authorization criteria implemented by the matching server 102 requires a matching transaction identifier, matching merchant, and matching transaction amount. Accordingly, the matching server 102 also extracts and stores the transaction identifier, the merchant information, and the amount from the received match request.

As will be appreciated, the matching server 102 may store additional information in respect of each received match request, either generated by the matching server 102 itself, extracted from the payloads of customer/merchant match requests. Such additional information may include, for example, additional information sent in the customer and/or merchant match requests such as transaction time, information as to what account to debit, merchant name, any loyalty program identifiers, any coupon details etc. The matching server 102 may also extract and store metadata from the match requests received (e.g. communications protocol information such as IP addresses and the like).

On receipt of a match request (from either a customer or merchant bank server) and population of the data structure with the corresponding match request record, the matching server 102 is configured to perform a matching process.

The matching process involves a search or look-up process in which the data structure is interrogated to determine whether a match request corresponding to the match request just received exists (i.e. has previously been received at the matching server 102 and stored in the data structure). Correspondence of match requests can be determined according to a minimum matching criteria. For example, if transaction identifiers are universally unique, the minimum matching criteria will be the transaction identifier (as two messages having the same transaction criteria are intended to be corresponding messages). Alternatively, if transaction identifiers are only unique to a particular merchant, then the minimum matching criteria may require consideration of both the transaction identifier and merchant identification information.

In the example of Table A:
On receiving match request assigned with identifier 00008 (and having transaction identifier 12345), the matching server 102 will not identify any corresponding match request and (for the time being) take no further action.
On receiving match request assigned with identifier 00009 (and transaction identifier ABCDE), the matching server 102 will not identify any corresponding match request and (for the time being) take no further action.
On receiving match request assigned with identifier 00010 (and transaction identifier ABCDE), the matching server 102 will identify that a match request meeting the minimum matching criteria has already been received (match request identifier 00009 with matching transaction identifier ABCDE).
However, as the amounts in the corresponding match requests differ ($50 v $100), the transaction authorization criteria is not satisfied and a match discrepancy is identified and processed by the match server 102 as discussed below.
On receiving match request assigned with matching sever identifier 00011 (and transaction identifier 12345), the matching server 102 will identify that a match request meeting the minimum matching criteria has already been received (match request identifier 00008 with matching transaction identifier 12345).
Further, the matching server 102 will identify that the transaction authorization criteria are satisfied as the amount and merchant information also match. In this case a match is identified and processed by the match server 102 as discussed below.
On receiving match request assigned with matching sever identifier 00012 (and transaction identifier !@#$%), the matching server 102 will not identify any corresponding match request and take no further immediate action.

If the matching server 102 identifies a match (i.e. two match requests are identified which satisfy the transaction authorization criteria), payment authorization for the transaction identified by the matching records is deemed to have been provided by the customer. This is on the basis that the matching server 102 has received match requests with matching transaction information from two independent and trusted sources: from the trusted customer bank server 104a (which, in turn, has received the transaction information from the trusted customer device 108), and from the trusted merchant bank server 104b (which, in turn, has received the transaction information from the trusted merchant apparatus 106).

If the matching server 102 identifies a match discrepancy (i.e. requests that meet the minimum match criteria but do not satisfy the transaction authorization criteria), payment authorization for the transaction is, not deemed to have been authorized. This is communicated to the relevant merchant and/or customer bank servers 104b/104a. Communication of a match discrepancy may be a simple communication noting that a discrepancy has occurred, or may include additional information as to the reason for the declined transaction (e.g. an amount or other discrepancy).

It will be appreciated that a variety of matching techniques/processes may be used. For example, a successful match may be determined where there is a correspondence other than identity between relevant information in the customer and merchant match requests. For example, the correspondence may be a partial matching of particular data in the transaction identifier. Alternatively, the correspondence may be a mathematical relationship between the transaction identifiers—e.g. a pair of reversed numerical sequences “12345” and “54321”, may be defined as a match. Further alternatively (or in addition) other information may also be used to identify a match, such as merchant information, amount, reported transaction time etc. The particular process/technique used will, of course, influence the transaction information that needs to be generated at the commencement of the authorization process, and the information communicated between the various entities throughout the process

Once matching sever 102 has matched two match requests, the two matched records are removed from the data structure or otherwise flagged as matched requests so that they do not need to be searched in future matching operations. Similarly, match requests that have been identified as being corresponding but having a discrepancy are also be removed from the data structure or otherwise flagged as discrepant records.

Matching server 102 is also programmed to remove or otherwise flag match requests that have expired—i.e. requests that have been in the data structure for over a defined time period (e.g. a certain number of hours or days have passed since receipt) and which have not been matched. In one embodiment, where an expired match request is identified the matching server 102 is configured to communicate a non-match message to the bank server 104 from which the un-matched match request was originally received, advising that bank sever 104 that the matching period has timed out and no match was identified. In alternative embodiments no such non-match message is communicated (non-match of a record instead being identified by the relevant bank server 104 due to not receiving a match confirmation within a time-out period).

On identifying a match, matching server 102 generates a merchant bank confirmation and communicates this to the merchant bank server 104b (communication 216). The merchant bank confirmation message includes at least the transaction identifier, and confirmation that the transaction identified by that identifier has been authorized by the customer (i.e. has been matched). The matching server 102 identifies the relevant bank server 104 to send the merchant bank confirmation message according to the bank server 104 from which the matched merchant match request was received.

On receiving the merchant bank confirmation message, the merchant bank server 104b generates a merchant confirmation and communicates this to the merchant apparatus (communication 218). The merchant confirmation also includes at least the transaction identifier and a confirmation that the transaction has been authorized. In some embodiments the merchant bank confirmation and merchant confirmation may be the same, though this does not need to be the case.

If the merchant bank server 104b does not receive the merchant bank confirmation within a predetermined time-out period, this may be deemed that the transaction has not been authorized by the customer (or has been authorized by the customer but has been declined by the customer bank for an alternative reason). In this case the merchant bank server 104b will time out and communicate a transaction declined message to the merchant apparatus 106 (in which case the transaction is declined). Similarly, if a non-match or match discrepancy message is received from the matching server 102 the merchant apparatus transmits a transaction declined message to the merchant apparatus 106.

Once the merchant confirmation is received at the merchant apparatus 106, the merchant is assured that the transaction has been approved by the customer (even though funds may not necessarily have actually been transferred to the merchant's account), and the sale can be finalized—e.g. the customer can be provided with the goods or services.

The merchant apparatus 106 may also be programmed/configured with a transaction time-out such that if confirmation of a transaction is not received within a predetermined time period the transaction is deemed not to have been authorized and is declined.

Where a transaction is declined a further attempt at authorization may, of course, be performed (commencing with the generation of new transaction information).

In some embodiments, matching server 102 may provide a notification message directly to merchant apparatus 106b via communications network 101 to inform the merchant that payment authorization has been approved. Direct notification may be beneficial if there is a large volume of frequent transactions from the merchant, for example a supermarket, as this will reduce the load on the merchant bank server 104b (in that it does not need to confirm the transaction with the merchant itself). In this embodiment, the merchant match request (and/or the customer match request) communicated to the matching server 102 include sufficient information to allow the matching server 102 to identify the relevant merchant apparatus 106 and communicate with it.

In order to confirm the matching of the match requests with the customer bank server 104a, a similar process is performed. I.e. the matching server 102 generates a customer bank confirmation and communicates this to the customer bank server 104a (communication 220). On receipt of the customer bank confirmation the customer bank server 104a knows that the transaction has been matched and that the payment confirmed by that message (identified, for example, by the transaction identifier) can be made.

Optionally, the customer bank server 104a may also generate a customer confirmation and communicate this to the customer device 108 (communication 222). This customer notification may not, however, be necessary as confirmation of the transaction will be indirectly reported to the customer through the merchant's finalization of the sale.

Although not the direct concern of the present invention, payment in respect of a matched transaction does still need to be made by transferring the transaction amount from the customer's bank to the merchant's bank. This transfer may take place using normal payment mechanisms such an existing transaction card network (e.g. in Australia, Consumer Electronic Clearing System (CECS or CS3) or similar systems for other Countries) and the information received by the bank servers 104 during the authorization process described above.

For example, in one embodiment the customer transaction request (and transaction information included therein) provides the customer bank server 104a with sufficient information to make payment to the merchant bank server 104b. For example, the customer bank server 104a may make payment to the merchant bank server 104b (identified using the merchant identification information) using the transaction identifier as a reference. The merchant bank server 104b can then use the transaction identifier to identify the correct account into which the transferred money is to be deposited.

The transaction information generated, and the information included in the various requests/confirmations described above, may include additional information to allow for the actual transfer of funds to be made in any desired way. For example, if effecting the transfer of funds requires the merchant bank server 104b to have details of the relevant customer bank server or bank account, this information may be provided to the merchant bank server 104b via matching server 102 (either in the merchant bank confirmation message or an alternative message). The matching server 102 may, in turn, be provided with the relevant customer bank/account details from the customer bank server 104a in the customer match request or an alternative message. In this way the merchant bank server 104b is provided with the customer bank/account details, however this information is still not communicated to the merchant or merchant apparatus 106.

Server, Apparatus and Device Operation

As described above, each of the matching server 102, bank servers 104a/104b, merchant apparatus 106, and customer device 108 is a computer processing system. Each of these systems includes memory (such as non-transient memory 130) in which instructions are stored which are executable by a processing unit of the system (such as unit 122) which enable or configure the system to generate, receive, communicate/transmit, and process the information/data as described above.

The instructions may form a stand alone program or application, or may be part of an instruction set for a broader application or program (for example a banking application or similar).

The instructions for a given system may transmitted to the system via communications network 101, or by other means (for example via a portable data storage device). By way of example, customer device 108 may obtain the instructions as an (or part of an) application obtained from either its bank or an application store, in which case the instructions are downloaded to the device 108 over network 101.

Described below are operations of each of the matching server 102, banking servers 104a/104b, merchant apparatus 106, and customer device 108 in order to authorize a transaction in accordance with embodiments of the invention. Embodiments of the invention include the methods themselves, the instructions which enable the various systems to implement the methods (stored, for example, in a non-transient computer readable medium such as memory 130), and actual matching servers, banking servers, merchant apparatuses, and customer devices configured by those instructions.

Matching Server 102

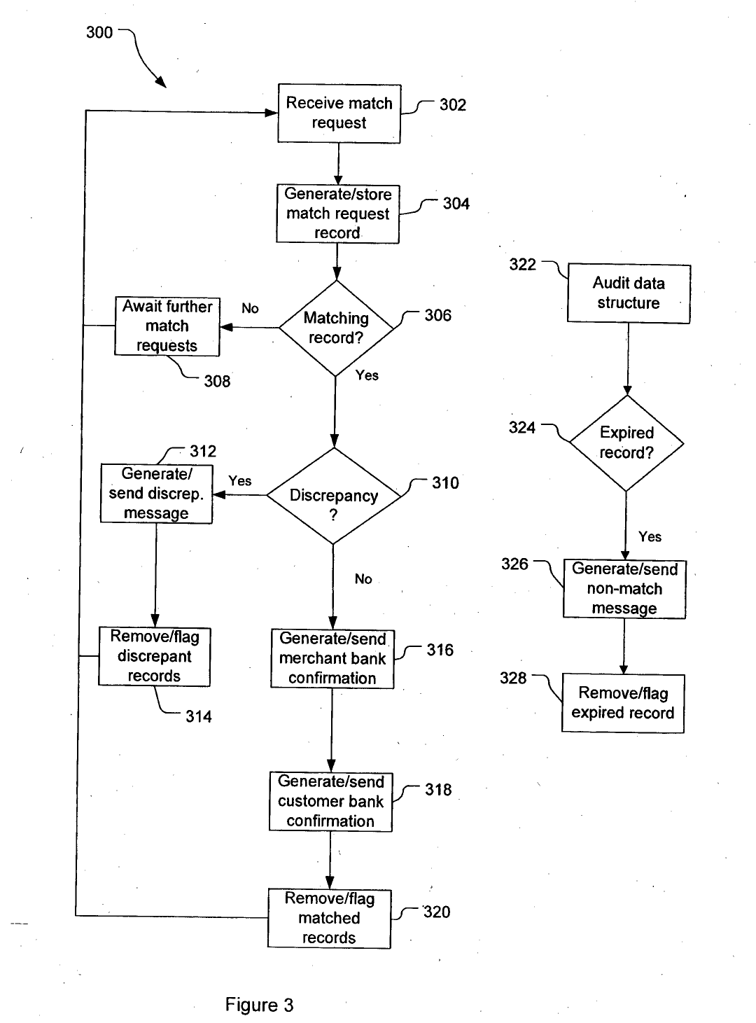

Referring to FIG. 3, a method 300 of operating a matching server 102 in accordance with an embodiment of the invention is illustrated.

At step 302, matching server 102 receives a match request communicated from a bank server 104. Match request may be a customer match request received from a customer bank server 104a (as per communication 208 in FIG. 2) or a merchant bank request received from a merchant bank server 104b (as per communication 212 in FIG. 2).

At step 304, matching server 102 generates a match request record with information from the match request received at step 302, and stores the match request record in a data structure (stored, in turn, in memory such as 130, for example).

At step 306, matching server 102 interrogates the data structure to determine whether a corresponding match request exists, based on the minimum matching criteria.

At step 308, if no corresponding match request exists, matching server 102 awaits the receipt of further match requests.

If a corresponding match request is identified, at step 310 matching server 102 checks to see whether all relevant data of the matching records match/correspond (i.e. whether the transaction authorization criteria is/are met), or whether there are discrepancies. This may include, for example, checking whether amounts, merchant information, and/or other information match.

At step 312, if the transaction authorization criteria is/are not meet a discrepancy is identified and matching server 102 generates a discrepancy message and communicates this to the customer bank server 104a and/or the merchant bank server 104b. The discrepant records are then flagged as being discrepant and/or removed from the data structure (optionally to be stored elsewhere for review purposes) at step 314.

At step 316, if the transaction authorization criteria is/are satisfied, matching server 102 generates a merchant bank confirmation and communicates the merchant bank confirmation to the merchant bank server 104b (communication 216 in FIG. 2). The merchant bank sever 104b is identified from the details of the merchant match request identified as a matching record in the interrogation of step 306 (e.g. from merchant identification information or derived from where the merchant match request was received from).

At step 318, the matching server 102 generates a customer bank confirmation and communicates the customer bank confirmation to the customer bank server 104a (communication 220 in FIG. 2). The customer bank sever 104a is identified from the details of the customer match request identified as a matching record in the interrogation of step 306 (e.g. from customer/customer account identification information or derived from where the customer match request was received from).

Steps 316 and 318 may be performed at any time after the match has been identified (i.e. step 312 may be performed before, after, or at the same time as step 310).

At step 320, the matching server 102 flags the two matched records as being matched or removes the two matched records from the data structure. If the records are removed from the data structure the matching server 102 may store them in an alternative data structure/memory for review purposes.

At step 322, which is initiated periodically (at regular timer intervals or defined times), server 102 conducts an audit of the data structure containing the match request records. At step 324 the server determines whether any expired records exist. Records will be considered expired if they are unmatched after a predetermined time has elapsed since receipt of the match request at the server.

At step 326, if an expired record is identified, the server generates and communicates a non-match message to the bank server from which the unmatched match request was received.

At step 328, the expired record identified is flagged as an expired record or removed from the data structure (again, optionally to be stored in an alternative data structure/memory for review purposes).

If no expired records are identified at step 328 the periodic process terminates.

Merchant Apparatus 106

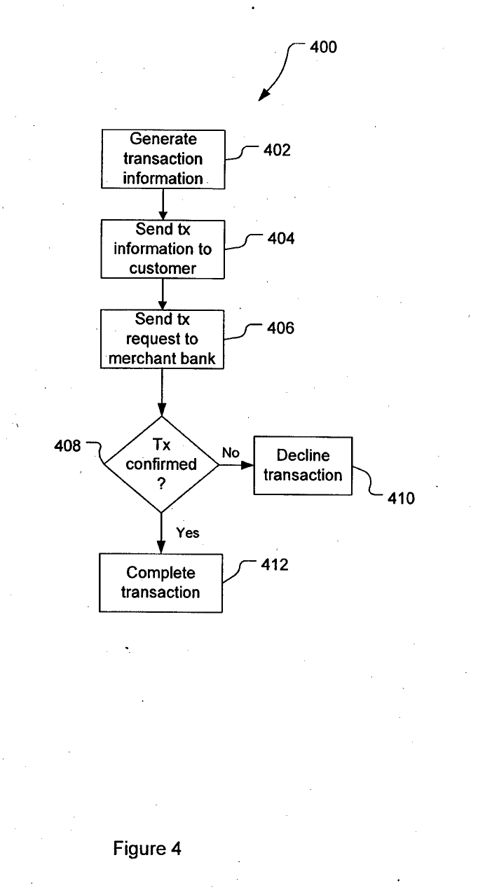

Turning to FIG. 4, a method 400 of operating a merchant apparatus 106 in accordance with an embodiment of the invention is illustrated.

At step 402, merchant apparatus 106 generates transaction information. This information includes (in one embodiment), a transaction identifier, a merchant identifier, and the transaction amount.

At step 404, merchant apparatus 106 communicates the transaction information to a customer device 108 (communication 204 in FIG. 2). As described above, the customer device 108 then generates and communicates a customer transaction request o its customer bank server 104a, and the customer bank server 104a in turn generates and communicates a customer match request to the matching server 102.

At step 406, merchant apparatus 106 communicates the transaction information to its merchant bank sever 104b (communication 210 in FIG. 2). As described above, the merchant bank server 104b then generates and communicates a merchant match request to the matching server 102.

Steps 404 and 406 may be performed at any time after the transaction information has been generated (i.e. step 404 may be performed before, after, or at the same time as step 406).

At step 408 the merchant apparatus waits for a merchant confirmation to be received (communication 218 in FIG. 2).

At step 410, if no merchant confirmation is received (or no merchant confirmation is received within a predefined time limit, or a transaction declined/transaction discrepancy message is received from the merchant bank sever 104b), the transaction is declined.

At step 412, if a merchant confirmation is received within the relevant time period (communication 218 in FIG. 2) the transaction is authorized and can be completed. As described above, this receipt of the merchant confirmation indicates that the matching server 102 has independently received corresponding match requests from the merchant and customer bank servers 104b/a, and therefore that the customer has approved the transaction. The transaction can then be processed as a normal payment.

Customer Device 108

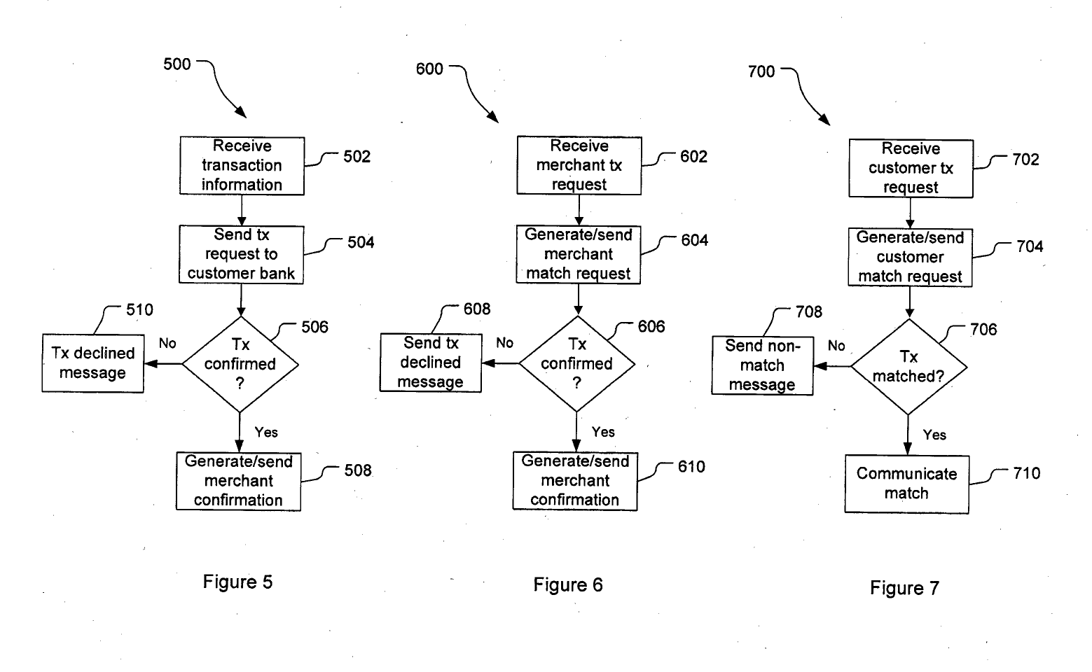

Turning to FIG. 5, a method 500 of operating a customer device 108 in accordance with an embodiment of the invention is illustrated.

At step 502, transaction information is received at the customer device 108 (communication 204 in FIG. 2). As described above the transaction information includes (in one embodiment), a transaction identifier, a merchant identifier, and the transaction amount, and may be received at the user device 108 in a variety of ways (NFC, scanned QR/bar code, infrared transmission, Bluetooth transmission, email, SMS, instant message, or even manual entry).

At step 504, the customer device 108 generates a customer transaction request and communicates this to its customer bank server 104a (communication 206 in FIG. 2). As described above, the customer bank server 104a then (provided all relevant checks are met) generates and communicates a customer match request to the matching server 102.

As discussed above, in certain embodiments the transaction server 102 is configured to communicate non match and/or discrepancy messages to the customer device 108 (either directly or via bank server 104a). In this case the customer device 108 awaits confirmation of the transaction approval at step 506. If the transaction authorized by the customer device 108 is matched at the matching server 102, this confirmation is received at the user device 108 at step 508.

Alternatively, if the transaction is not completely matched a non-match or discrepancy message is received at step 510.

Merchant Bank Server 104

FIG. 6 illustrates a method 600 of operating a merchant bank server 104b in accordance with an embodiment of the invention.

At step 602, the merchant bank server 104b receives a merchant transaction request (communication 210 in FIG. 2).

At step 604, the merchant bank server 104b uses the information in the merchant transaction request to generate a merchant match request, and communicates the merchant match request to the matching server 102 (communication 212 in FIG. 2).

At step 606, the merchant bank server 104b waits for a merchant bank confirmation to be received from the matching server 102 (communication 216 in FIG. 2).

At step 608, if no merchant bank confirmation is received (or no merchant bank confirmation is received within a predefined time limit, or a non-match message is received, or a discrepancy message is received), the transaction is considered not to be authorized. In this case the merchant bank server 104b communicates a transaction declined message to the merchant apparatus 106. In alternative embodiments, however, the merchant apparatus 106 may be configured to time out on its own, in which case the merchant bank 104b may not be configured to send a transaction declined message.

At step 610, if a merchant bank confirmation is received within the relevant time period (communication 216 in FIG. 2) the transaction is authorized and can be completed. In this case, the merchant bank server 104b generates and communicates a merchant confirmation to the merchant apparatus 106 (communication 218 in FIG. 2). As described above, receipt of the merchant bank confirmation indicates that the matching server 102 has independently received corresponding match requests from the customer and merchant bank servers 104a/104b, and therefore that the customer has approved the transaction.

Customer Bank Server 104a

FIG. 7 illustrates a method 700 of operating a customer bank server 104a in accordance with an embodiment of the invention.

At step 702, the customer bank server 104a receives a customer transaction request (communication 206 in FIG. 2).

At step 704, the customer bank server 104a uses the information in the customer transaction request to generate a customer match request, and communicates the customer match request to the matching server 102 (communication 208 in FIG. 2).

At step 706, the customer bank server 104a waits for a customer bank confirmation to be received from the matching server 102 (communication 220 in FIG. 2).

If no customer bank confirmation is received (or no customer bank confirmation is received within a predefined time limit), at step 708 the transaction is considered not to have been matched and the customer bank server 104a communicates (in the present embodiment) a non-match message to the customer device 108.

In the present embodiment, at step 710, if a customer bank confirmation is received within the relevant time period (communication 220 in FIG. 2), the customer bank server 104a generates and communicates a customer confirmation to the customer device 108 (communication 222 in FIG. 2). As discussed above, in alternative embodiments the customer bank server 104a may not send a customer confirmation to the customer device 108.

### ALTERNATIVE EMBODIMENT

In the embodiment described above, the transaction information communicated between the merchant apparatus 106 to the customer device 108 includes a transaction identifier, merchant information, and the transaction amount. This information is then sent through to the matching server 102 (via the customer and merchant bank servers 104) for transaction approval.

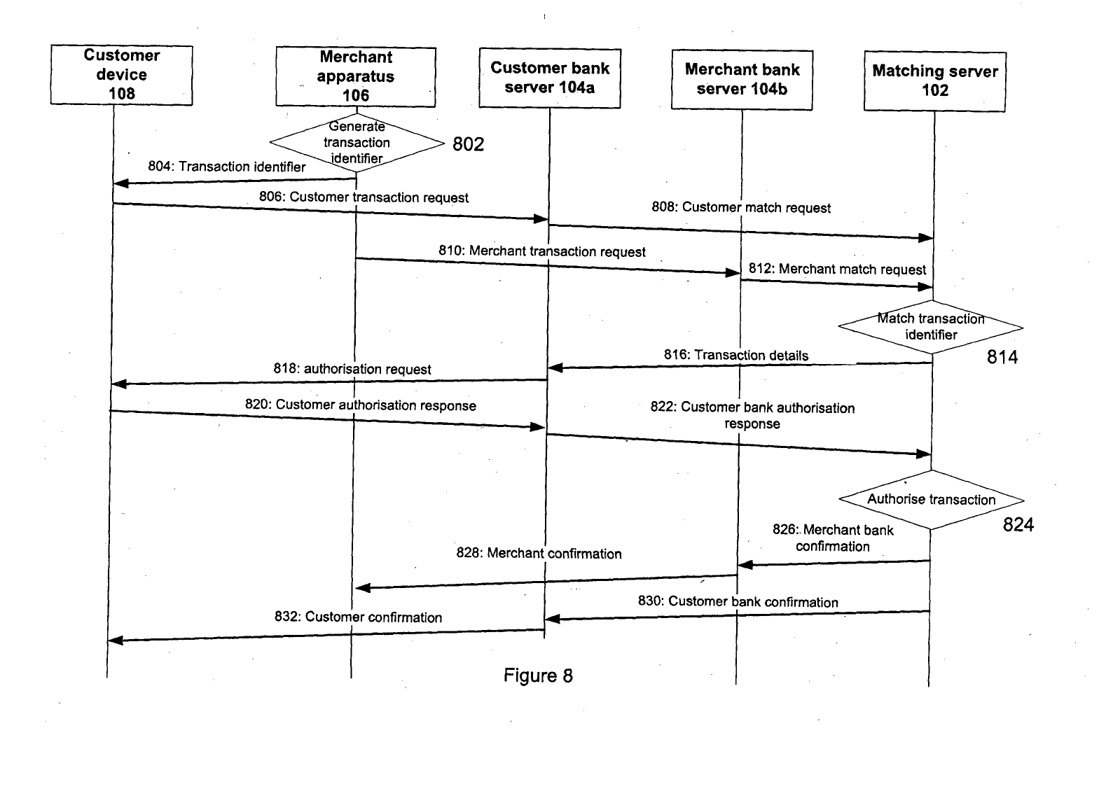

In an alternative embodiment of the invention, depicted in FIG. 8, the merchant apparatus 106 need only generate a transaction identifier at 802 for communication with the customer device at 804.

In this case the customer device 108 receives the transaction identifier and generates and sends a customer transaction request to the customer bank server 104a (communication 806) which, in turn generates and sends a customer match request to the matching server 102 (communication 808). This is in a similar fashion to the embodiment described above, though while both messages include the transaction identifier neither message includes amount or merchant identification information.

The merchant apparatus 106 generates and sends a merchant transaction request to the merchant bank server 104b (communication 810), which then generates and sends a merchant match request to the matching server 102 (communication 812). These messages are also similar to those described in the above embodiment, and do include merchant identification information and transaction amount information.

The matching server 102 receives both the customer match request and the merchant match request and identifies these as matching requests (at 814). Because the customer match request has not been made in light of either the merchant or amount information, however, the matching server 102 in this embodiment does not treat matched records at this stage as customer authorization of the transaction identified by the transaction identifier. Rather, on matching a merchant and customer match request the matching server 102 uses the merchant identification and amount information from the merchant match request to generate a transaction details message and communicate this to the customer bank server 104a (communication 816).

The customer bank server 104a extracts relevant information from the transaction details message and generates and sends an authorization request to the customer device 108 (communication 818), the authorization request including the transaction amount and the merchant identifier.

The authorization request message is received at the customer device 108. If the customer amount and merchant details are as expected, the customer can authorize the transaction by activating an authorization control (e.g. a touch screen or other button on the device 108), which causes the device 108 to generate and send an authorization response to the customer bank server 104a indicating that the transaction is authorized (communication 820). The customer bank server 104a then communicates a customer bank authorization response to the matching server 102 (communication 822), which includes the transaction identifier and indicates the transaction is authorized.

Only on receipt of the match authorization message does the matching server 102 treat the transaction identified by the transaction identifier as being matched (at 824). At this point the matching server 102 can complete the transaction authorization process as per the embodiment described above (e.g. by sending a merchant bank confirmation to the merchant bank server 104b at communication 826, and sending a customer bank confirmation to the customer bank server 104a at communication 830).

If the amount and merchant details received in the authorization request message are not as expected, the customer may activate a control to indicate that the transaction is declined (or may make no response which, after a time-out period, is considered to be a declined transaction). In this case the device 108 can generate and send an authorization response to the customer bank server 104a (communication 820) indicating that the transaction is declined, and the customer bank sever 104a communicates a customer bank authorization response message to the matching server 102 (communication 822), including the transaction identifier and indicating the transaction is declined.

In alternative embodiments the customer bank server 104a and/or the matching server 102 may be configured to treat the transaction as declined if no authorization message is received within a set time-out period.

In a further alternative implementation, the customer may configure their account details such that the customer bank server 104a automatically authorizes transactions which satisfy a transaction criteria (despite the customer transaction request not including merchant identification or amount information). For example, the customer may configure their account so that any transaction request under a predefined monetary amount (e.g. $50) is approved without having to manually approve the transaction on receipt of an authorization request message. In this case, if the transaction details received at the customer bank server 104a in communication 816 satisfy the transaction criteria (e.g. the transaction amount is less than $50), the customer bank server 104a can automatically communicate the customer bank authorization response to the matching server 102 in communication 822, without having to communicate the authorization request to the customer device or wait for the customer authorization response.

It should be apparent to that the systems and methods described above provide a number of advantages over existing payment authorization systems. For example:
A customer can authorize a transaction without having to communicate any information (confidential or otherwise) to a merchant.
A customer can authorize a transaction using a portable electronic device (such as a smart phone) without having to have or show a transaction card.
Additional information can be communicated between a merchant's apparatus and the customer, such as detailed receipts, loyalty programs, offers redeemed etc.
A high level of security is provided using relatively limited security infrastructure.
Existing infrastructure and payment systems are used to facilitate authorization and payment.
Customers are provided with greater choice with respect to transaction payment options.

It will be understood that the invention disclosed and defined in this specification extends to all alternative combinations of two or more of the individual features mentioned or evident from the text or drawings. All of these different combinations constitute various alternative aspects of the invention.

1. A method of operating a matching server for facilitating authorization of payment for a transaction between a customer and a merchant at a point of sale, the method including the steps of:
receiving a merchant match request from a merchant bank server, the merchant match request originating from a merchant apparatus and including transaction information in respect of the transaction;
receiving a customer match request from a customer bank server, the customer match request originating from a customer device and including transaction information in respect of the transaction;
performing a matching operation to determine whether the transaction information included in the merchant match request and the transaction information included in the customer match request satisfy a transaction authorization criteria;
if the transaction authorization criteria is satisfied:
determining the payment for the transaction to be authorized,
generating a merchant bank confirmation confirming authorization of the payment for the transaction, and
communicating the merchant bank confirmation to one or both of the merchant bank server and the merchant apparatus.

2. A method according to claim 1, wherein in response to the transaction authorization criteria being satisfied, the method further includes:
generating a customer bank confirmation confirming authorization of the transaction and communicating the customer bank confirmation to one or both of the customer bank server and the customer device.

3. A method according to claim 1, wherein each of the merchant match request and the customer match request further include merchant identification information and/or transaction amount information.

4. A method according to claim 1, wherein the customer match request further includes a customer bank identifier for identifying the customer bank.

5. A method according to claim 1, wherein the transaction information in the merchant match request and the transaction information in the customer match request include a transaction identifier.

6. A method according to claim 1, wherein the transaction information is generated by the merchant apparatus and communicated to the customer device.

7. A method according to claim 1, wherein the transaction information is communicated to the customer device using NFC data exchange format (NDEF).

8. A method according to claim 1, wherein the transaction information is encoded in an image displayed at the merchant apparatus and captured by an image capture device of the customer device.

9. A method according to claim 1, wherein the transaction authorization criteria requires one of a complete matching, a partial matching, or a relationship between the transaction information included in the customer match request and the transaction information included in merchant match request.

10. A method of operating a merchant apparatus at a point of sale to facilitate authorization of a payment for a transaction between a customer and a merchant, the method including:
generating transaction information including at least a transaction identifier;
communicating the transaction information to a customer device, the customer device being configured to communicate the transaction information to a customer bank server, the customer bank server being configured to communicate the transaction information to a merchant matching server in a customer match request;
generating a merchant transaction request including at least the transaction information;
communicating the merchant transaction request to a merchant bank server, the merchant bank server being configured to communicate the transaction information to the matching server in a merchant match request; and
receiving a merchant confirmation confirming authorization of the payment for the transaction,
wherein the merchant confirmation is received only if the matching server receives a customer match request which, when compared with the merchant match request, satisfies a transaction authorization criteria.

11. A method according claim 10, wherein the merchant confirmation is received from the matching server or from the merchant bank server.

12. A method according to claim 10, wherein the transaction information is communicated to the customer device using NFC data exchange format (NDEF).

13. A method according to claim 10, wherein the transaction information is encoded in an image and displayed by the merchant apparatus for capture by an image capture device of the customer device.

14. A method according to claim 13, wherein the image is a QR code.

15. A method of operating a customer device at a point of sale to facilitate authorization of a payment for a transaction between a customer and a merchant, the method including:
receiving transaction information from a merchant apparatus, the transaction information including at least a transaction identifier;
generating a customer transaction request including at least the transaction information;
communicating the customer transaction request to a customer bank server, the customer bank server being configured to communicate the transaction information to a matching server in a customer match request.

16. A method according to claim 15, wherein the transaction information is received using NFC data exchange format (NDEF).

17. A method according to claim 15, wherein the transaction information is received by operating the customer device to capture an image displayed by the merchant apparatus.

18. A method according to claim 17, wherein the image is a QR code.

19. A method of operating a merchant bank server for facilitating authorization of a payment for a transaction between a customer and a merchant at a point of sale, the method including the steps of:
receiving a merchant transaction request from a merchant apparatus, the merchant transaction request including transaction information;
generating a merchant match request including at least the transaction information;
communicating the merchant match request to a matching server, the matching server being configured to receive a customer match request from a customer bank server, the customer match request including customer match request transaction information received at the customer bank server from a customer device; and
receiving from the matching server a merchant bank confirmation confirming authorization of the transaction,
wherein the merchant bank confirmation is received only if the matching server determines the merchant match request and the customer match request satisfy a transaction authorization criteria.

20. A method according to claim 19, further including:
generating a merchant confirmation confirming authorization of the payment for the transaction; and
communicating the merchant confirmation to the merchant apparatus.

21. A method of operating a customer bank server for facilitating authorization of a payment for a transaction between a customer and a merchant at a point of sale, the method including the steps of:
receiving a customer transaction request from a customer device, the transaction request including transaction information generated by a merchant apparatus and communicated to the customer device;
generating a customer match request including at least the transaction information;
communicating the customer match request to a matching server, the matching server being configured to receive a merchant match request from a merchant bank server, the merchant match request including merchant match request transaction information received at the merchant bank server from the merchant apparatus; and
receiving from the matching server a customer bank confirmation confirming authorization of the transaction,
wherein the customer bank confirmation is received only if the matching server determines the merchant match request and the customer match request satisfy a transaction authorization criteria.

22. A method according to claim 21, further including:
generating a customer confirmation confirming authorization of the payment for the transaction; and
communicating the customer confirmation to the customer device.

23.-24. (canceled)

25. A computer readable storage medium including instructions executable by a computer processing device to cause the device to:
receive a merchant match request from a merchant bank server, the merchant match request originating from a merchant apparatus and including transaction information in respect of a transaction;
receive a customer match request from a customer bank server, the customer match request originating from a customer device and including transaction information in respect of the transaction;
perform a matching operation to determine whether the transaction information included in the merchant match request and the transaction information included in the customer match request satisfy a transaction authorization criteria;
in response to the transaction authorization criteria being satisfied:
determine the payment for the transaction to be authorized,
generate a merchant bank confirmation confirming authorization of the payment for the transaction, and
communicate the merchant bank confirmation to one or both of the merchant bank server and the merchant apparatus.

26. A computer readable storage medium including instructions executable by a computer processing device to cause the device to:
generate transaction information including at least a transaction identifier;
communicate the transaction information to a customer device, the customer device being configured to communicate the transaction information to a customer bank server, the customer bank server being configured to communicate the transaction information to a matching server in a customer match request;
generate a merchant transaction request including at least the transaction information;
communicate the merchant transaction request to a merchant bank server, the merchant bank server being configured to communicate the transaction information to the matching server in a merchant match request; and
receive a merchant confirmation confirming authorization of the payment for the transaction,
wherein the merchant confirmation is received only if the matching server receives a customer match request which, when compared with the merchant match request, satisfies a transaction authorization criteria.

27. A computer readable storage medium including instructions executable by a computer processing device to cause the device to:
receive transaction information from a merchant apparatus, the transaction information including at least a transaction identifier;
generate a customer transaction request including at least the transaction information;
communicate the customer transaction request to a customer bank server, the customer bank server being configured to communicate the transaction information to a matching server in a customer match request.

28. A computer readable storage medium including instructions executable by a computer processing device to cause the device to:
receive a merchant transaction request from a merchant apparatus, the merchant transaction request including transaction information;
generate a merchant match request including at least the transaction information;
communicate the merchant match request to a matching server, the matching server being configured to receive a customer match request from a customer bank server, the customer match request including customer match request transaction information received at the customer bank server from a customer device; and
receive from the matching server a merchant bank confirmation confirming authorization of the transaction,
wherein the merchant bank confirmation is received only if the matching server determines the merchant match request and the customer match request satisfy a transaction authorization criteria.

29. A computer readable storage medium including instructions executable by a computer processing device to cause the device to:
receive a customer transaction request from a customer device, the transaction request including transaction information generated by a merchant apparatus;
generate a customer match request including at least the transaction information;
communicate the customer match request to a matching server, the matching server being configured to receive a merchant match request from a merchant bank server, the merchant match request including merchant match request transaction information received at the merchant bank server from the merchant apparatus; and
receive from the matching server a customer bank confirmation confirming authorization of the transaction,
wherein the customer bank confirmation is received only if the matching server determines the merchant match request and the customer match request satisfy a transaction authorization criteria.
